(19) United States
(12) Patent Application Publication
(10) Pub. No.: US 2015/0261426 A1
(43) Pub. Date: Sep. 17, 2015

(54) METHOD AND APPARATUS FOR COMMUNICATION USING IMAGES, SKETCHING, AND STAMPING

(71) Applicant: Ustringer LLC, Lake Oswego, OR (US)

(72) Inventor: Marty Mianji, Lake Oswego, OR (US)

(21) Appl. No.: 14/657,762

(22) Filed: Mar. 13, 2015

Related U.S. Application Data
(60) Provisional application No. 61/952,842, filed on Mar. 13, 2014.

(51) Int. Cl. G06F 3/0484; G06F 3/0482; H04L 29/06

(52) U.S. Cl. CPC G06F 3/04847; H04L 65/403; G06F 3/0482

(57) ABSTRACT

A method for creating and specifying stamps for a piece of content includes, in part, defining a first set of user interface items for selecting a first stamp and defining a second set of user interface items for selecting a second stamp. The method optionally includes defining a third set of user interface items for selecting a relationship operator stamp that identifies a relationship between the first stamp and the second stamp. The method optionally includes defining a fourth set of user interface items for adding user input and a fifth set of user interface items for receiving user input.

### CLAIM OF BENEFIT TO PRIOR APPLICATION

This application claims the benefit of U.S. Provisional Application 61/952,842, entitled “Method and Apparatus For Communication Using Image, Sketching, and Stamping, filed Mar. 13, 2014, which is incorporated herein by reference.

### BACKGROUND OF THE INVENTION

The dominant public-facing Internet applications have varying notions of how they view conversations. For instance, some public-facing Internet Applications chiefly act as the facilitators of conversations between its user communities where individual and corporate voices may mix (e.g., Facebook), some primarily have a question-centric view of conversations between itself and its users (e.g., Google), and some merely act as a multicast channel through which individuals and corporations may be heard (e.g., Twitter).

However, conversations aren't always necessarily about search, nor should they be limited to exchanges between groups of individuals who already know one another. Thus far, conversations that take place in web-based applications and over mobile devices have also been predominantly linguistically based. Photographs and the ability to sketch on them are a natural, seamless and language-agnostic form of communication that can remove linguistic barriers and facilitate more efficient conversations. Furthermore, organizing conversations around activities is needed to bring clarity to every conversation and multicasting conversations through social media will allow an application to leverage both networks of data and the wisdom of crowds in order to conduct more meaningful conversations.

### BRIEF SUMMARY OF THE INVENTION

Some embodiments of the present invention implement a method for communication through images using sketching and stamping. In some embodiments, this method is implemented using a mobile application with Graphical User Interface (GUI) tools. In other embodiments, this method is implemented using a web application with GUI tools. In still other embodiments, this method is implemented on a social networking website with GUI tools.

In some embodiments, images refer primarily to photographic images, but one skilled in the art will understand that it is not limited to this and may also include free-form sketch images, videos, and other types of multimedia. Stamps are comprised of predefined user-selectable content (e.g., user-selectable icons) that carry specific meanings and can be used to express sentiments either individually or strung together. Some stamps may also encompass software encapsulating agents. In some embodiments, written or spoken text can also be added to a stamp after selecting it, and may be displayed as a text overlay when the user touches the stamp.

Some embodiments provide a stamping mechanism for tagging images. In some embodiments, this stamping mechanism includes providing the GUI tools to display and tag images using stamps or sketches as a means to create tag chains to convey sentiments about an image in a communication.

Some embodiments also provide an adding mechanism for creating new stamps to add to the database of stamps available to a user. In some embodiments, this mechanism includes a means to create a sketch of a proposed stamp image, a means to approve the proposed stamp, and a means to vote on proposed stamps. In other embodiments, this adding mechanism includes a means to create a sketch of a proposed stamp image, a means to approve the proposed stamp, and a means to purchase the stamp for use without voting.

Some embodiments provide a delivery mechanism for sending user-generated content from one to one user or one to many users through a communications network. In various embodiments, the communications network may be a network of networks (e.g., the Internet), a private network, a public network, a wireless network, etc. In some embodiments, this mechanism includes a means to send the content privately (e.g., through SMS) or publicly (e.g., posted on a social media website such as Twitter, Facebook, Tumblr, etc.). Some embodiments define a communication as a single unit of user input generated using a client application which includes one or more of the following: a corresponding image, sketches, and/or one or more stamps.

Some embodiments provide a browsing mechanism for viewing all communications associated with an image from one or more users. In some embodiments, this mechanism includes two types of browsing: Tree Model browsing and Flat Model browsing. In some embodiments, the browsing mechanism also alerts a user when a new communication is received and is ready for browsing in the form of a queue notification.

The example embodiments below are described using a client application on a mobile device, but one skilled in the arts will recognize that the present invention can be used with any client application on any platform, system, or device (e.g., iOS, Android, Web, or Tumblr).

### Terminology

| | |
|---|---|
| The Application | One of the seyZme client applications: iOS, Android, Web, and Tumblr. |
| The Server | The seyZme Server, also referred to as “Server” or “Client Application |
| | Server.” |
| Stamp | A visual hash tag that is predefined and shepherded by seyZme. |
| Stamp ID | A unique identifier that identifies each stamp. |
| Stampede | A database of all Stamps |
| GUID | A unique identifier that identifies the user; this value is generated by the |
| | Application and is sent to the server. |
| seyZ ™ | A single unit of user input generated using seyZme (an example client |
| | application) that is also referred to as a “unit of conversation”; a seyZ is also |
| | must have at least one of the following: a corresponding photograph, sketches, |
| | and/or one or more stamps. |
| reseyZ ™ | A seyZ that is based on an existing seyZ. |
| seyZ ID | A unique identifier associated with a seyZ that is generated by the server. |
| Parent ID | The seyZ ID of the seyZ that another seyZ may be based on. The Parent ID |
| | must be passed down to the server by the Application. |
| Root seyZ ™ | A seyZ that does not have a parent; the Parent ID for such a seyZ is not |
| | passed down to the Server by the Application and is set to zero by the Server |
| | automatically. |
| Branch seyZ ™ | A seyZ that does have a parent; the Parent ID for such a seyZ must be passed |
| | down to the Server by the Application. |
| seyZ comment | Collection of the Stamps that appear at the bottom of a seyZ and are not |
| | permanently placed on the associated photograph/sketch. |
| Top Level seyZ | seyZ that the “owns” of unique photographs/sketch; a Top Level seyZ may be |
| | a Root seyZ or a Branch seyZ. |

### BRIEF DESCRIPTION OF THE DRAWINGS

The novel features of the invention are set forth in the appended claims. However, for purpose of explanation, several embodiments of the invention are set forth in the following figures.

FIG. 1 illustrates a computer system network through which some embodiments of the invention are implemented.

FIG. 2 illustrates the architecture of an example client application of some embodiments of the invention running on a mobile device.

FIG. 3 illustrates the architecture of an example client mobile application server of some embodiments of the invention.

FIG. 4 illustrates an example graphical user interface (“GUI”) at first glance for an example client mobile application of some embodiments of the invention.

FIG. 5 illustrates an example stamp tool input GUI for an example client mobile application of some embodiments of the invention.

FIG. 6 conceptually illustrates how some embodiments determine what activity-specific stamps to display in the stamp tools input GUI.

FIG. 7 illustrates an example unit of conversation creation GUI for some embodiments of the invention with added Comment Type input.

FIG. 8 illustrates an example unit of conversation creation GUI for some embodiments of the invention with added input to modify an image.

FIG. 9 illustrates a sample unit of conversation creation GUI on a Web application for some embodiments of the invention.

FIG. 10 illustrates a sample unit of conversation creation GUI on a Social Media Website application.

FIG. 11 illustrates an example Stamp proposal GUI component for some embodiments of the invention.

FIG. 12 illustrates an example Stamp proposal GUI component for some embodiments of the invention.

FIG. 13 illustrates an example Stamp proposal GUI component for some embodiments of the invention.

FIG. 14 illustrates an example Stamp proposal GUI component for some embodiments of the invention.

FIG. 15 illustrates an example Stamp proposal GUI component for some embodiments of the invention.

FIG. 16 illustrates an example Stamp proposal GUI component for some embodiments of the invention.

FIG. 17 illustrates a unit of conversation creation GUI on an example client mobile application.

FIG. 18 illustrates a unit of conversation creation GUI on an example client mobile application.

FIG. 19 illustrates a unit of conversation creation GUI on an example client mobile application.

FIG. 20 illustrates a unit of conversation creation GUI on an example client mobile application.

FIG. 21A illustrates a browsing GUI on an example client mobile application.

FIG. 21B illustrates a browsing GUI on an example client mobile application.

FIG. 22 illustrates an example GUI of some embodiments indicating one or more communications have been received.

### DETAILED DESCRIPTION OF THE INVENTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed below.

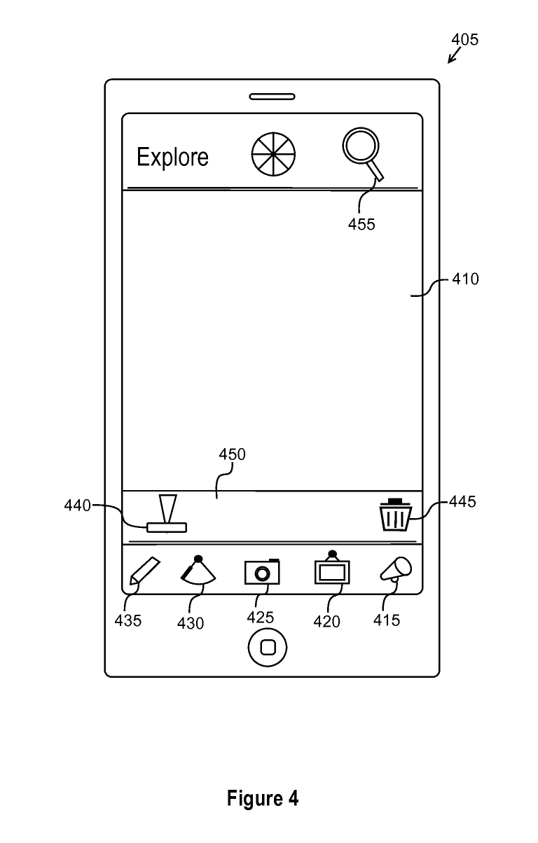

Some embodiments of the invention implement a method for communication using images, sketching, and stamping. In some embodiments, communication is based on sending units of conversation which are each a single unit of user-generated input that is comprised of at least one or more of the following: an image (e.g., a photograph), sketches, and/or one or more stamps. FIGS. 4-7 illustrate creating a unit of conversation using an example client mobile application. A unit of conversation can then be submitted to a client application and delivered to one or more other users through either a private or public communication network. In some embodiments, users can browse public communications to view the mini-conversations associated with each image.

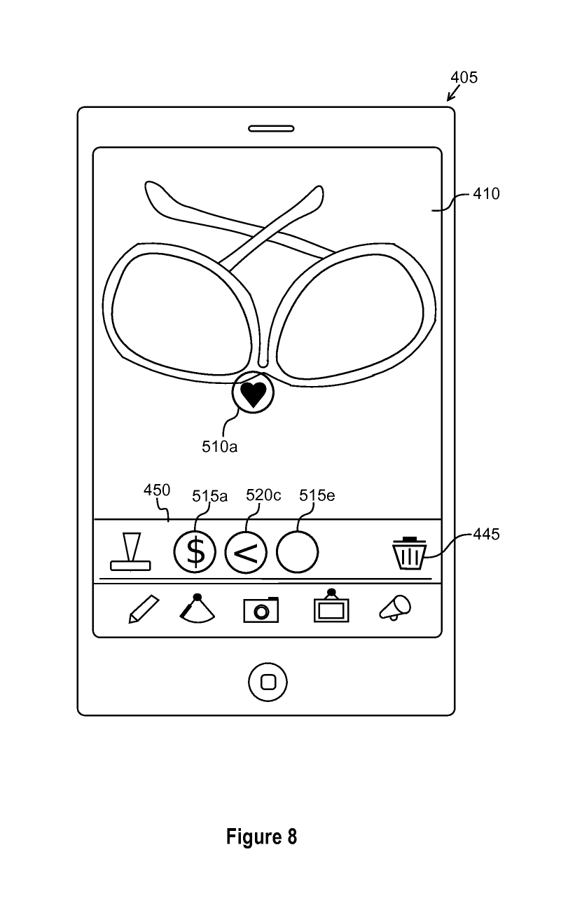

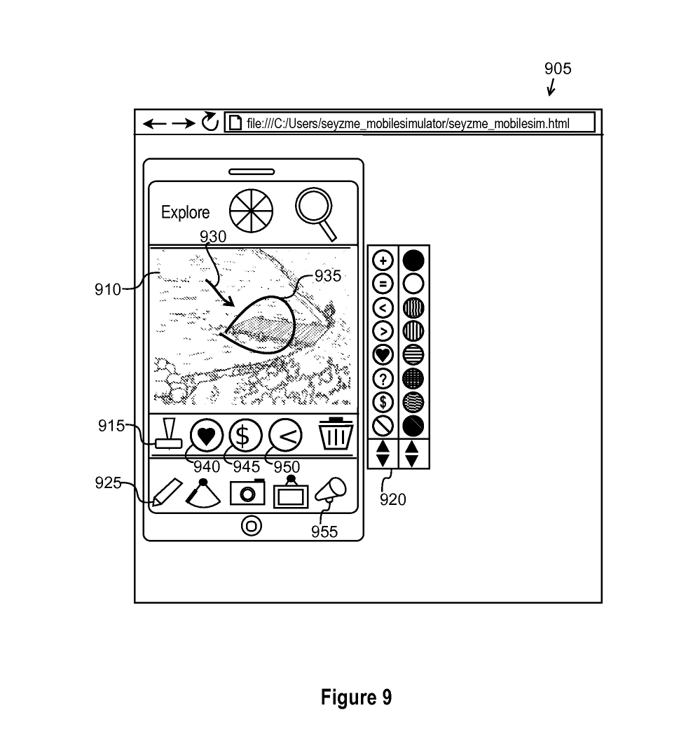

Although some embodiments show these processes being implemented on a sample mobile interface, one of ordinary skill in the art will realize that many of these processes can be used through client applications on any platform, system, and device. For example, the client application can be used on smart phones, web browsers, and desktop clients. FIGS. 8-9 illustrate additional implementations of creating a communication using a sample web application client.

Several more detailed embodiments of the invention are described in the sections below. Section I describes a computer system network with which some embodiments of the invention are implemented. Section II describes a method for communication using images, sketching, and stamping through illustrating user activities on an example client mobile application using a GUI to create a unit of conversation, propose new stamps to be added to the database of stamps available for use in creating a unit of conversation, and viewing units of conversation received either privately or on a public platform (e.g., a social networking website such as Tumblr, Twitter, or Facebook).

I. Communication System Network

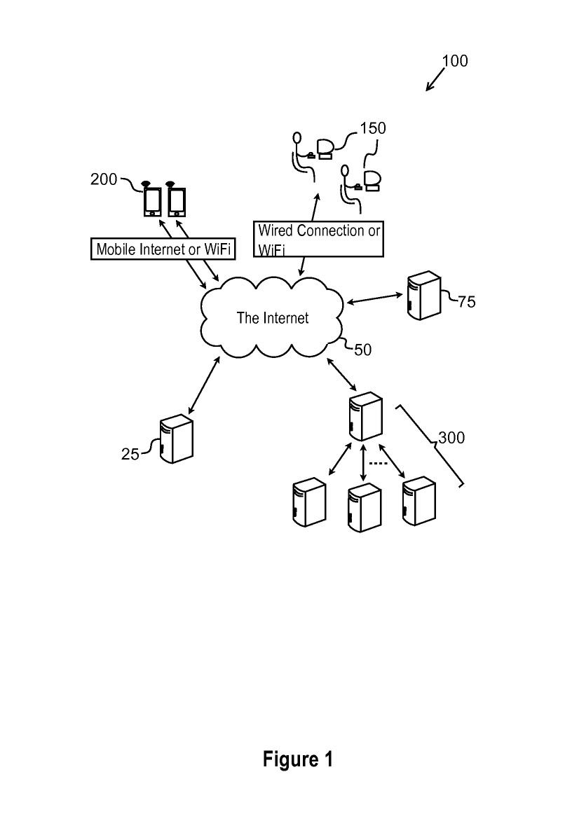

FIG. 1 shows a Computer System Network 100 that includes a number of communication devices that are in communication with servers in accordance with one embodiment of the present invention. Computer System Network 100 includes two or more communication devices connected to any number of servers via the Internet 50. In some embodiments, the two or more communication devices may be comprised of any number of Mobile Device 200 (e.g., iOS phone, Android phone, etc.) and Non-mobile Device 150 (e.g., desktop computer, laptop, etc.), and in any combination. Computer System Network 100 also includes one or more of Social Media Website System 25, Mobile Device Server 75, and Client Application Server 300, all of which communicate with Mobile Device 200 and Non-mobile Device 150 via the Internet 50. In the example of FIG. 1, each Mobile Device 200 is further configured to include an example client mobile application in accordance with the description further below.

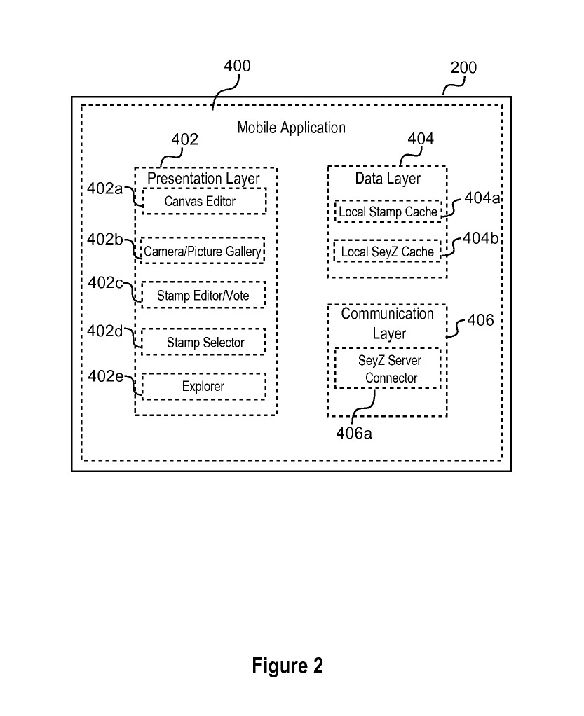

FIG. 2 illustrates the architecture of an example Mobile Application 400 running on Mobile Device 200. Mobile Application 400 shows a number of components of a software application running on Mobile Device 200 and is configured to enable social mobile communication in accordance with one embodiment of the present invention. Mobile Application 400 includes Presentation Layer 402, Data Layer 404, and Communication Layer 406. Presentation Layer 402 further includes Canvas Editor 402a, Camera & Picture Gallery 402b, Stamp Editor/Vote module 402c, Stamp Selector module 402d, and Explorer Module 402e; Data Layer 404 further includes Local Stamp Cache 404a and Local Communications Cache 404b; and Communication Layer 406 further includes Application Server Connector 406a.

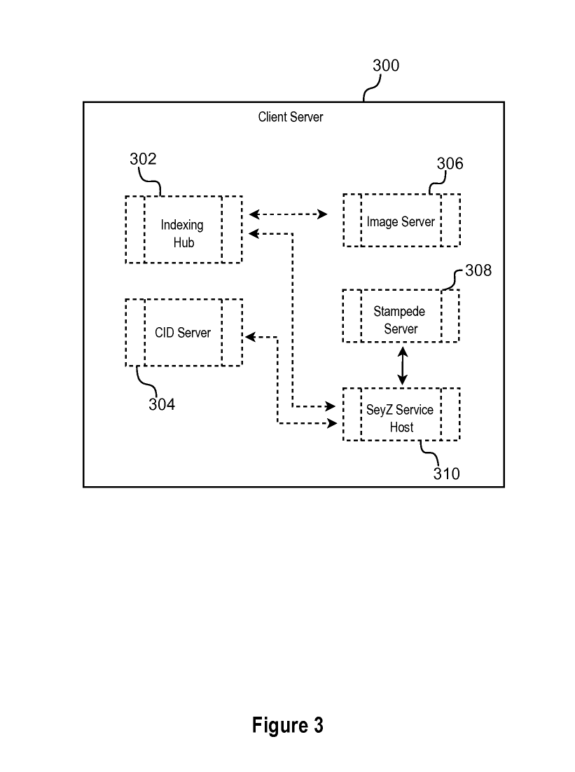

FIG. 3 illustrates the architecture of an example Client Application Server 300 that supports the Mobile Application 400 that is running on Mobile Device 200 in FIG. 1 and includes Indexing Hub 302, Content Intelligence and Delivery Server (CID Server) 304, Image Server 306, Stampede Server 308 and Service Host 310.

Presentation Layer 402, Data Layer 404, and Communication Layer 406 all work together, and in conjunction with Client Application Server 300, to implement the user activities as described further below in accordance with one embodiment of the present invention.

Various embodiment of the present invention may be implemented in software, hardware or a combination of both. Some embodiments of the invention may be implemented in computer instructions stored in a computer readable storage medium.

### II. User Activities on an Example Client Application within the Communication System Network

Some embodiments of the invention implement a method of communication using images, sketching and stamping. The following is a description of user activities on example client applications that illustrate creating units of conversation, proposing stamps for voting, browsing units of conversations and conversation threads, and receiving notification queues.

A. Creating a Unit of Conversation on an Example Mobile Client Application

In the example client mobile application, a user may create a unit of conversation in the client application on a mobile device by sketching, stamping, or using a combination of both on a blank canvas or image (e.g., photograph, video, etc.). FIGS. 4-7 show an example of how to create a unit of conversation and illustrate a method of conveying sentiments through images using sketches and stamps. In some embodiments, one or more lists of stamps are provided to the user. Each stamp has a different meaning, and, based on the order of stamps under the images or placement of stamps on the images, conveys different sentiments about the images.

FIG. 4 shows an example GUI 405 of an example client mobile application that some embodiments of the invention automatically generate and display when a user opens the application. In some embodiments, GUI 405 also includes: Image Editor 410; Action Buttons 415, 420, 425, 430, 435, and 440; Stamp Eraser Tool 445; Comment Editor 450; and Explorer Tool 455.

In the example of FIG. 4, Action Buttons 415, 420, 425, 430, 435, and 440 are individual touch-selectable buttons and communicate user commands to the application. Action Button 415 prompts the application to submit the content in Image Editor 410 to the application server for processing and delivery; Action Button 420 prompts the application to display a gallery of images stored on the application device that the user can select to display in Image Editor 410; Action Button 425 prompts the application to capture a photographic image or video using the mobile device's built in camera and display it in Image Editor 410; and Action button 430 prompts the application to erase all added input from Image Editor 410 except for any stamps added by using Action Button 440.

Action Buttons 435 and 440 allow the user to add input to Image Editor 410 and/or Comment Editor 450. Action Button 435 prompts the application to activate a sketch tool so the user can draw or make notations directly in Image Editor 410. Action Button 440 prompts the application to display a Stamp Selector GUI. In some embodiments, the color selection options and stamp selection options are displayed as individual touch-selectable buttons in a separate GUI, but one skilled in the arts will understand that they may be displayed in any other arrangement (e.g., in example GUI 405 as a drop down menu, rollover display menu, etc.). One of ordinary skill in the art will understand that the touch-selectable Action Buttons 415, 420, 425, 430, 435, and 440 may also be displayed in any other arrangement and may include fewer or more Action Buttons as well.

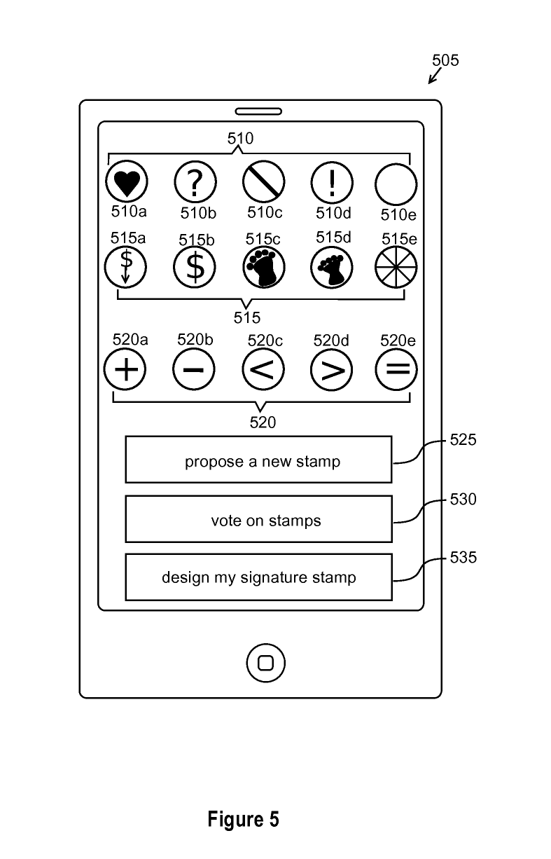

In some embodiments, once the user has captured an image in Image Editor 410 and selects Action Button 440 to choose stamps, a Stamp Selector GUI is displayed in the application. FIG. 5 illustrates an example Stamp Selector GUI 505 in the example client application and includes: Universal Stamps 510, Activity Specific Stamps 515, and Operator Stamps 520. In some embodiments, a user can select multiple stamps to input in either or both Image Editor 410 and Comment Editor 450 to convey multiple sentiments about an image.

Universal Stamps 510 are always displayed and available for use in all contexts, and in the present example include: Like Stamp 510a, Question Stamp 510b, Dislike Stamp 510c and Comment Stamp 510d. Personal Stamp 510e is a signature stamp that each user may choose to design for their exclusive use in some embodiments.

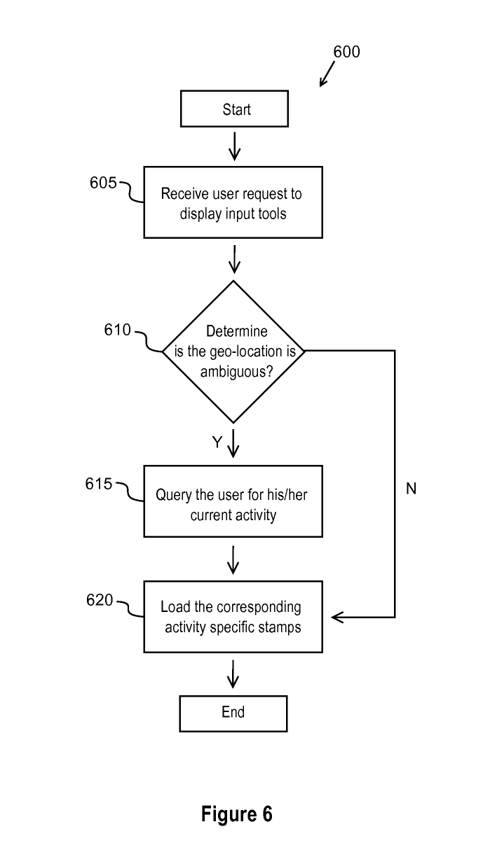

Activity Specific Stamps 515 are context specific, and FIG. 6 presents a process 600 performed by some embodiments of the invention to determine which Activity Specific Stamps 515 to display in a given context. The process 600 begins when the Presentation Layer 402 in FIG. 2 receives (at 605) a user request to display stamp input tools. In some embodiments, the user request is automatically received when a user selects Stamp Tool 440 in the mobile client application GUI 405.

Once the user request is received, the process (at 610) assesses the user's location based on a variety of parameters to determine where the user is and what activity he or she is engaging in. For example, in some embodiments, Client Application Server 300 shown in FIG. 1 can determine the context using location information (e.g. Global Positioning System (“GPS”) coordinates) on Mobile Device 200 and display the corresponding Activity Specific Stamps 515 in Stamp Selector module 402d of Client Application 400. In some embodiments, where the user's geo-location either cannot be found using the mobile device's GPS or cannot be matched to a corresponding activity at a specific geo-location, the process (at 620) will prompt the user to manually enter his or her activity. In some embodiments, the server-prompted query is displayed as a text box for the user to manually enter an activity (e.g. writing with a finger on a touchscreen or a mobile device keyboard), but one skilled in the arts will understand that it may be displayed in any other arrangement (e.g. as a user-selectable drop down menu, rollover display menu, etc.).

The example of FIG. 5 illustrates one embodiment of the invention where the user has selected Stamp Tool 440 and based on the geo-location of the user's mobile device, the process 600 determines that the user is in a shopping mall and has loaded shopping specific stamps to display in GUI 505 as Activity Specific Stamps 515a-515e. These shopping specific stamps include: Sale Stamp 515a, Price Stamp 515b, Big Stamp 515c, Small Stamp 515d, and Color Stamp 515e.

Operator Stamps 520 are always displayed in GUI 505 when the user selects Stamp Tool 440 in FIG. 4. They are available for use in all contexts, and allow a user to string together multiple stamps in a variety of combinations to define a relationship between two or more stamps and convey a compound sentiment using stamp calculus. In the example of FIG. 5, Operator Stamps 520 include: Plus Stamp 520a, an addition operator (+); Minus Stamp 520b, a subtraction operator (−); Less Than Stamp 520c, a less than operator (<); More Than Stamp 520d, a greater than operator (>); and Equals Stamp 520e, and equal operator (=). In some embodiments, Operator tags may include but are not limited to those illustrated in FIG. 5.

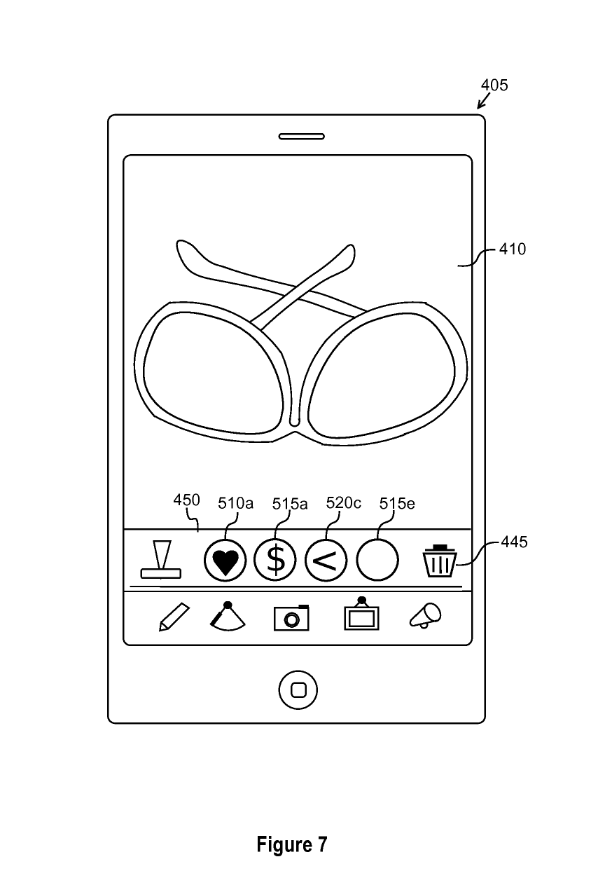

FIG. 7 illustrates an example shopping GUI 405 after input is added to the Comment Editor 450. In some embodiments, the selected stamps are displayed, by default, below Image Editor 410 in Comment Editor 450 in the order they are selected. If an Operator Stamp 520 is selected from the example Stamp Selector GUI 505 in FIG. 5, the order in which multiple stamps are selected is important because the Operator Stamp conveys a relational sentiment between two stamps. Stamps displayed in Comment Editor 450 are categorized and stored by Client Application Server 300 as a Comment Type sentiment.

In the example of FIG. 7, Like Stamp 510a, Price Stamp 515a, Less Than Stamp 520c, and White Color Stamp 515e were selected in that order from Stamp Selector GUI 505 in FIG. 5 and are displayed in that order under the image of a pair of sunglasses in Image Editor 410. In some embodiments, the user can individually remove one or more stamps by clicking on a stamp and dragging it into the Stamp Eraser Tool 445. Read together, the stamps in the example of FIG. 7 convey a Comment Type sentiment communicating that the user loves these glasses and that color of the glasses is more important to him than the price.

In some embodiments, the user can also move the order of the selected stamps around in Comment Editor 450 or onto different parts of the image itself in Image Editor 410 to create different sentiments and/or modify the image. FIG. 8 illustrates the same example shopping GUI 405 after the user selects Stamps 515a, 520c, and 515e from the example Stamp Selector GUI 505 in FIG. 5 but moves one of the stamps onto the image. In this example, the user has moved Like Stamp 510a from Comment Editor 450 onto the image in Image Editor 410 by dragging it with his finger on the screen. It is now on top of the sunglass frame. In some embodiments, moving a stamp into Image Editor 410 makes it become a permanent part of the image itself and modifies it. Read together now, the stamps in the example of FIG. 8 now convey a slightly different sentiment. Application Server 300 now only recognizes and stores the Comment Type sentiment to convey that the color of the glasses is more important to the user than the price. In the present example, the image is now also modified to include Like Stamp 510a and will be stored as a separate image that conveys that the user loves the frame of the glasses.

Other example embodiments of client applications include an Internet World Wide Web browser application or as a plugin on social networking websites (e.g., Tumblr). For each example embodiment, a user can sketch, stamp, or add both sketches and stamps on a blank canvas or on an image (e.g., photograph, video, etc.) using similar mechanisms.

B. Creating a Unit of Conversation on an Example Desktop Client Application

FIG. 9 illustrates creating a unit of conversation in an example Web application after both sketch and stamp inputs are added. The photograph is loaded into an Image Editor 910 in the Web application browser. The example client Web application also displays the same input tools, Stamp Tool 915 and Sketch Tool 925, as the example mobile application from FIG. 4. One of ordinary skill in the art will understand that the types of input tools are not limited to these two types and may include fewer or more types, displayed in the same or any other arrangements (e.g., drop down menu, text list, etc.), in other embodiments of the invention.

In the present embodiment, selection of Stamp Tool 915 prompts a Stamp Selector GUI 920 to be displayed next to Image Editor 910 in a multi-row, scrollable arrangement, but one skilled in the arts will understand that they may be displayed in any other arrangement (e.g., as a static display in the browser, as a drop down menu, etc.).

In the example of FIG. 9, the user has selected Sketch Tool 925 to draw Circle Sketch 935 and Arrow Sketch 930 on the photograph in Image Editor 910, circling and pointing to a dock in it. This modifies the image to draw emphasis to that part of the photograph. The user has also selected Like Stamp 940, Less Than Stamp 945, and Cost Stamp 950 from Stamp Selector GUI 920 to create a Comment Type sentiment about the dock to convey that the cost of the dock is more important than how much he likes it. In the example of FIG. 9, the user has created a Unit of Conversation that includes an Image with a photograph and sketches, and an associated Comment Type stamp string sentiment. The user can then select Action Button 955 to submit this unit of conversation to the client server for processing and delivery.

C. Creating a Unit of Conversation on an Example Social Network Client Application

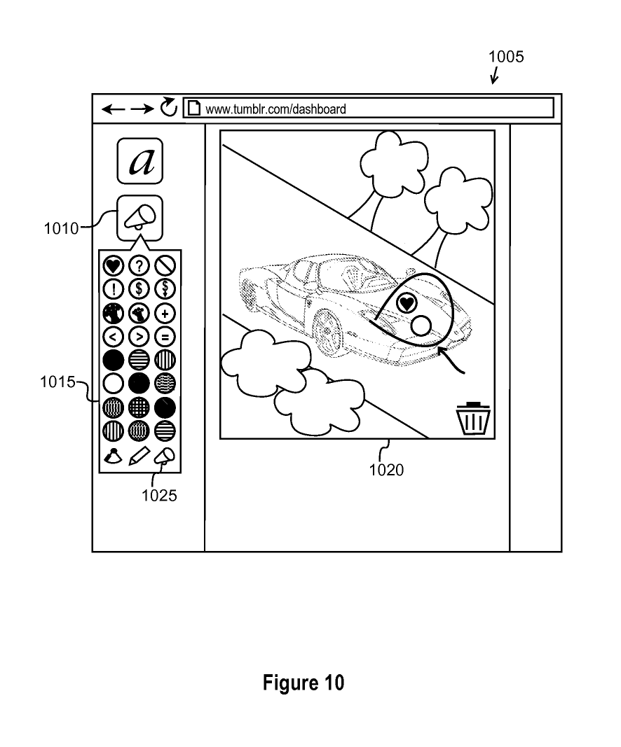

FIG. 10 illustrates creating a unit of conversation on an example social networking website, Tumblr. In the example of FIG. 10, all action buttons and input tools are displayed when a user selects Action Button 1010. Selecting Action Button 1010 prompts a GUI 1015 to be displayed in the web browser. In the present example, GUI 1015 displays all possible action buttons and input tools available for use. One skilled in the art will understand that the types of action buttons and input tools are not limited to what is show in the example of FIG. 10, and may include fewer or more options, displayed in the same or any other arrangements (e.g., drop down menu, text list, etc.), in other embodiments of the invention.

In the example of FIG. 10, the user has selected two stamps, moved them onto the photograph in Image Editor 1020, and sketched a circle on the photograph around the stamps with an arrow pointing at it. The user in this example has modified the image but not left any Comment Type sentiment. The stamps and sketches modify the original photograph and become a part of the modified image. In the example of FIG. 9, the user has created a Unit of Conversation that includes an Image modified with a photographs, sketches, and stamps, but no associated Comment Type stamp string sentiment. The user can then select Action Button 1025 to submit this unit of conversation to the client server for processing and delivery.

D. Proposing a New Stamp

In some embodiments, stamps are grouped and organized by context which may be determined using geo-location information contained on a mobile device. Each context group contains the stamps that are applicable within that context. The client application determines the current context (chiefly for mobile clients) and presents applicable stamps to the user. Examples of context are: shopping, dining, sports, etc.

In some embodiments, all of the stamps supported by a client application system are categorized into the following eight types: Universal Stamps, Personal Stamps, System Stamps, Community Stamps, Group Stamps, Smart Stamps, Sponsored Stamps, and Operator Stamps, and are further described below in accordance with one embodiment of the present invention. The lists of stamps in the example embodiments are not exhaustive of all possible stamps and new stamps are created by both the client application system and users to increase the total database of stamps. Returning to the example Stamp Selector GUI 505 in FIG. 5, a user can start the stamp proposal process by selecting “Propose a New Stamp” button 525 (e.g., Group Stamp, Community Stamp, Sponsored Stamp) or “Design My Signature Stamp” button 535 (e.g., Personal Stamp).

Universal Stamps, Operator Stamps, and System Stamps are created by the system in some embodiments. Universal Stamps are applicable in all contexts and FIG. 5 shows example Universal Stamps 510a-510e. These stamps are permanently available for use. Operator Stamps perform stamp operations and when combined with other stamps, are used to communicate messages related to the images they are attached to. They are applicable in all contexts and illustrated in the example of FIG. 5 as stamps 520a-520d. System Stamps are created and maintained by the system from time to time in order to extend the nomenclature of stamps in the stamp database. They may be available all the time or may be context-specific depending on the type of stamp created. The system also creates and maintains new context from time to time as well.

Smart Stamps encapsulate software agents that perform programming functions on behalf of the user. One example of a Smart Stamp is a Clock Stamp. If placed onto an image, a user that is browsing that image can click it (e.g., as a touch selectable icon on a client mobile application) and view a message from the user that created it such as displaying how long that user has been at that location. In some embodiments of the invention, selecting the Clock Stamp when browsing the image will prompt the application to creating an event reminder such as “meet at this location on Tuesday at 5 pm” if the application device has calendaring capabilities. Another example of a Smart Stamp is a Location Stamp. A user can select the Location Stamp and place it on an image of a location (e.g., sunset on a beach). When another user is browsing the image and selects the stamp, it may prompt the application to open an interactive map and give directions to the location of the image if the application device has mapping capabilities (e.g., Global Positioning System).

Community Stamps, Group Stamps, and Personal Stamps may be created by users in some embodiments. Community Stamps are proposed by users and are voted on by the entire community of users. Approved Community Stamps are available to all users and are maintained by the system as further described below. Group Stamps are proposed by users in the same way as Community Stamps but are only voted on and made available to a group of individuals defined by the creator of the proposal if approved. Approved Group Stamps are available only to that group of individuals and are maintained by the system as further described below. Approved Community Stamps and Group Stamps may be available all the time or may be context-specific depending on the type of stamp created. Personal Stamps are proposed by an individual user, and if approved, are only available to that user. Personal Stamps though are always available to use in all contexts.

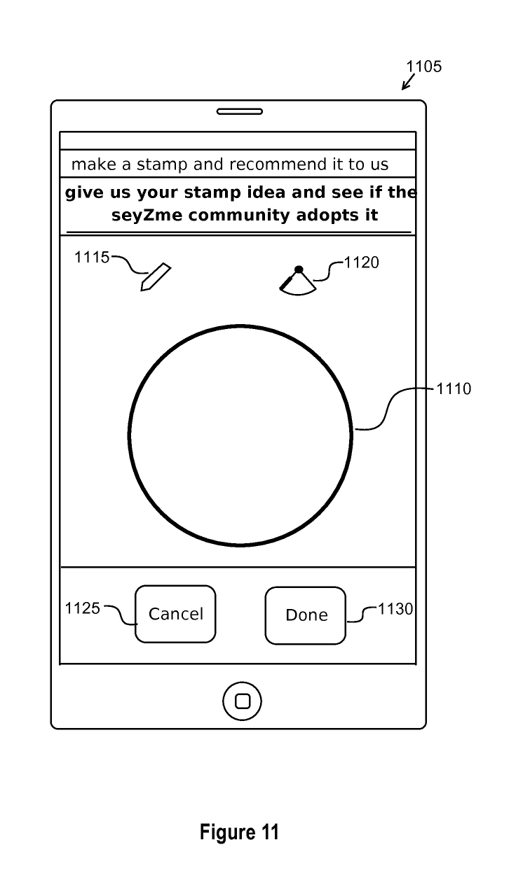

FIGS. 5, and 11-16 illustrate an example of the process of proposing a user generated stamp for voting. Returning to the example GUI 505 in FIG. 5, a user can select “propose a new stamp” button 525 to create a Community Stamp or a Group Stamp. In the present example, selecting “propose a new stamp” button 525 displays the example GUI 1105 in FIG. 11. The example GUI 1105 includes Sketch Box 1110, Sketch Tool 1115, Eraser Tool 1120, Done Button 1125, and Cancel Button 1130.

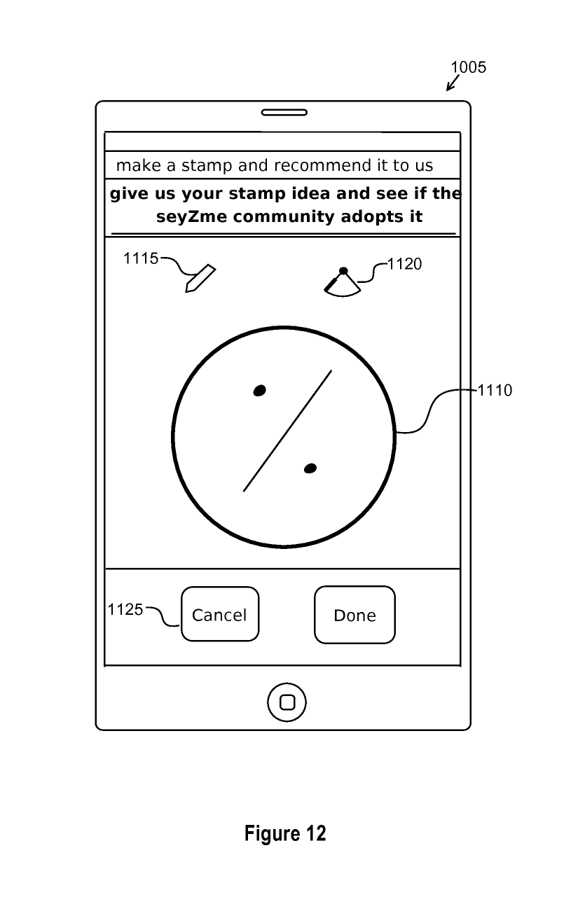

FIG. 12 illustrates GUI 1105 after the user selects Sketch Tool 1115 and draws a stamp image proposal in Sketch Box 1110. The user can also upload a more artistically enhanced version of the proposed stamp image in some embodiments. The user can select Eraser Tool 1120 to clear all drawings in Sketch Box 1110 in some embodiments and select Done Button 1125 when the user has finished drawing.

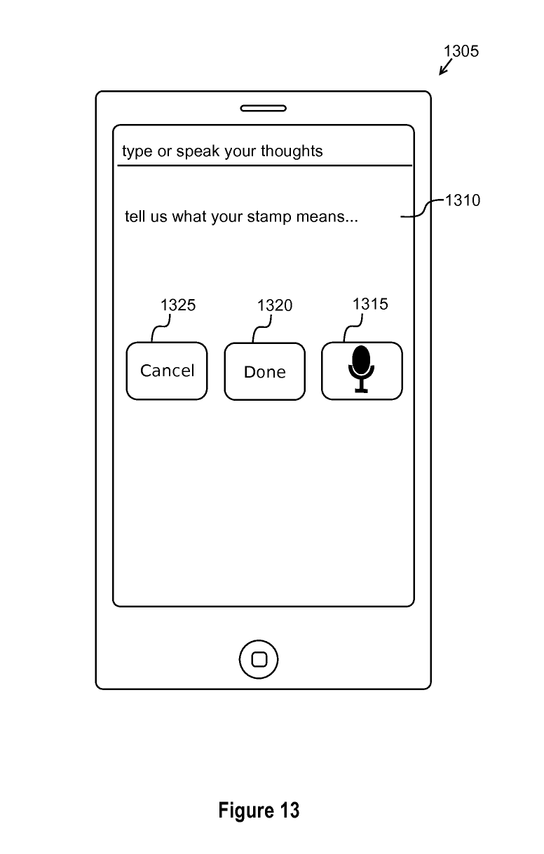

In some embodiments, the application will prompt the user to enter a description of the proposed new stamp once the user selects the Done Button 1125. FIG. 13 illustrates an example comment GUI 1305 that is displayed after the Done Button 1125 has been selected. GUI 1305 includes Text Box 1310, Talk Button 1315, Done Button 1320, and Cancel Button 1325.

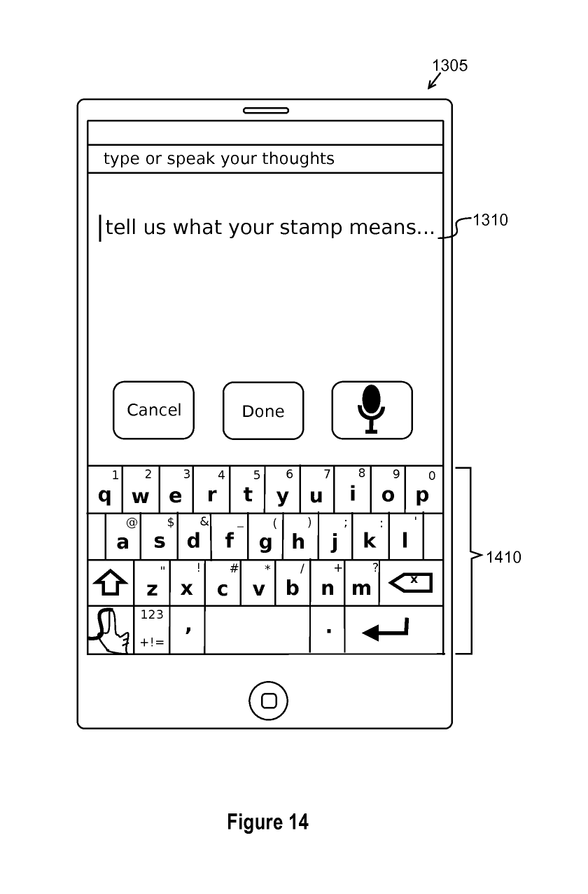

Upon selecting Text Box 1310, a Keyboard Tool 1410 is introduced in some embodiments as a touch screen overlay in GUI 1305 as illustrated in FIG. 14. The user can use Keyboard Tool 1410 to enter written text in Text Box 1310 to describe what the proposed new stamp means. In some embodiments, the user must choose one or more applicable contexts for his or her proposed stamp from a list of existing contexts.

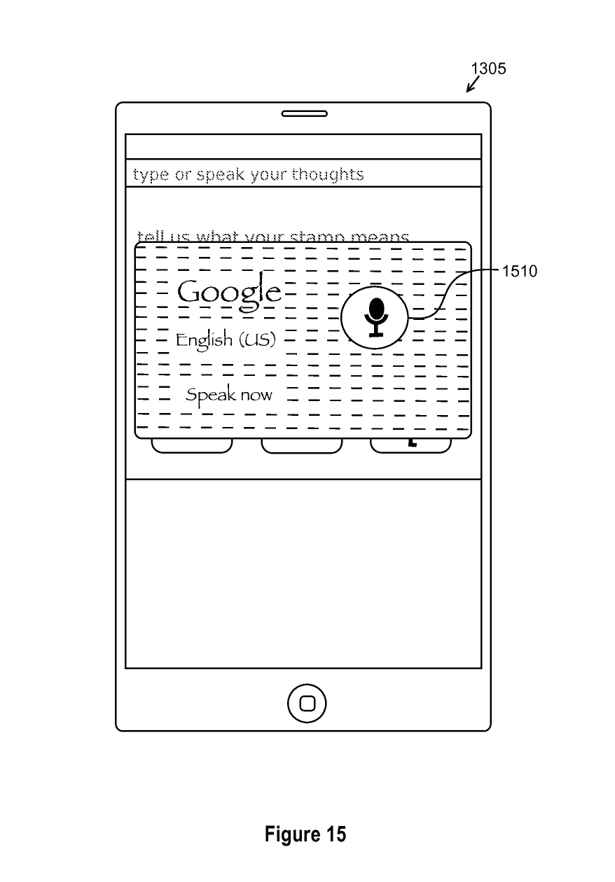

Returning to FIG. 13, the user can select Talk Button 1315 in some embodiments to describe what the proposed new stamp means using spoken text. Upon selecting Talk Button 1315, a Talk Tool 1510 is introduced as an overlay in GUI 1305 as illustrated in FIG. 15. In some embodiments Talk Tool 1510 uses the built-in microphone on the application device to record what the user says and converts it from natural language to text.

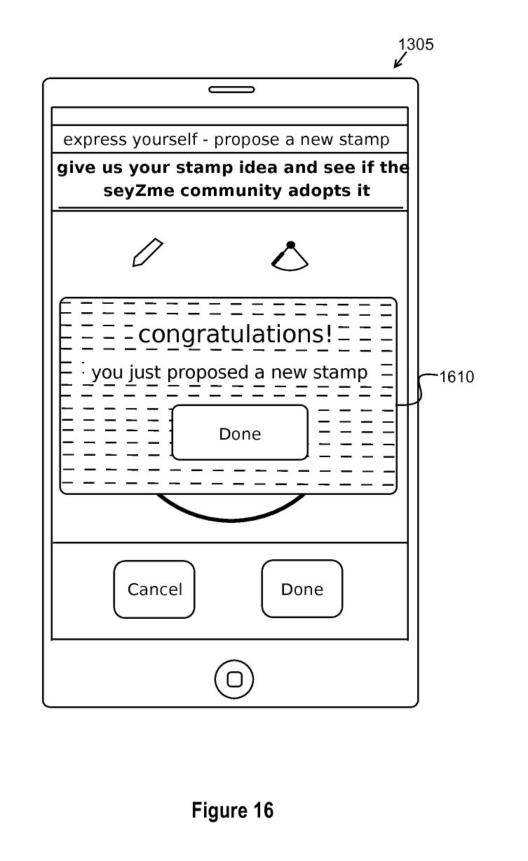

Once the user is finished explaining what the proposed new stamp means through written or spoken text, the user can select Done Button 1320 to submit the proposal to the application. FIG. 16 illustrates GUI 1305 after Done Button 1320 is selected and displays a confirmation message 1610 that the proposal was received by the Server. In some embodiments, the application will send all proposed new stamps to the Server for processing and quality checking to prepare for the voting process by other application users.

In conjunction with the new stamp proposal capabilities described above, some embodiments provide the capabilities to create new Sponsored Stamps. In some embodiments, these stamps are a special category of stamps that are directly added to the stamp database after a quality check by the client application Server and without being voted on by paying a fee. Different entities (e.g., people, companies, organizations) can use these special stamps for different purposes such as to advertise products or services, to perform market research, etc. In some embodiments these sponsored stamps are displayed more prominently, apart from other non-sponsored stamps. In some other embodiments, they may be displayed elsewhere along with other non-sponsored stamps.

E. Voting on Stamps

All of the users within the seyZme Community may view and vote on proposed Community Stamps. Voters may browse proposed stamps for one particular context or all contexts.

A voter may also offer to enhance the image of a proposed stamp. Such an offer must be accepted by the stamp's creator. As such, stamp definitions contain two parameters, Creator and Artist, and these parameters may not always be assigned to the same user.

In some embodiments, Sponsored Stamps may be proposed by corporate clients and similarly enhanced by users through this mechanism.

F. Browsing

Returning to the example GUI 405 in FIG. 4, a user can select Explorer Button 455 to display a Browsing GUI to browse communications that are comprised of one or more units of conversation commenting on the Image submitted to the server with an original unit of conversation, and can be between one or more users.

In browsing mode for some embodiments, a client application Server returns the Root and Branch seyZ that have been sent by a user, namely all of the seyZ associated with the user that include the original seyZ (Parent ID of zero) and the reseyZ generated by that user (Parent ID of nonzero). The Application controls the current index and ranges of the seyZ returned. For each seyZ, the Application receives the number of reseyZ associated with that seyZ; said reseyZ may only consist of seyZ Comment and/or a modified image (e.g., an added sketch or stamp moved onto an existing photograph).

In browsing mode, for some other embodiments, a client application Server returns the Top Level seyZ associated with a user. These include the seyZ originated by the user (Parent ID of zero), reseyZ generated by the user that have a modified image (Parent ID of nonzero), and reseyZ generated by other users based on the user's seyZ where the image has been modified (Parent ID of nonzero). For each seyZ, the client Application can retrieve and display the reseyZ that in the case of this interface would be a Comment Type seyZ only. In this example, the Application controls the current Index and ranges with this call as well.

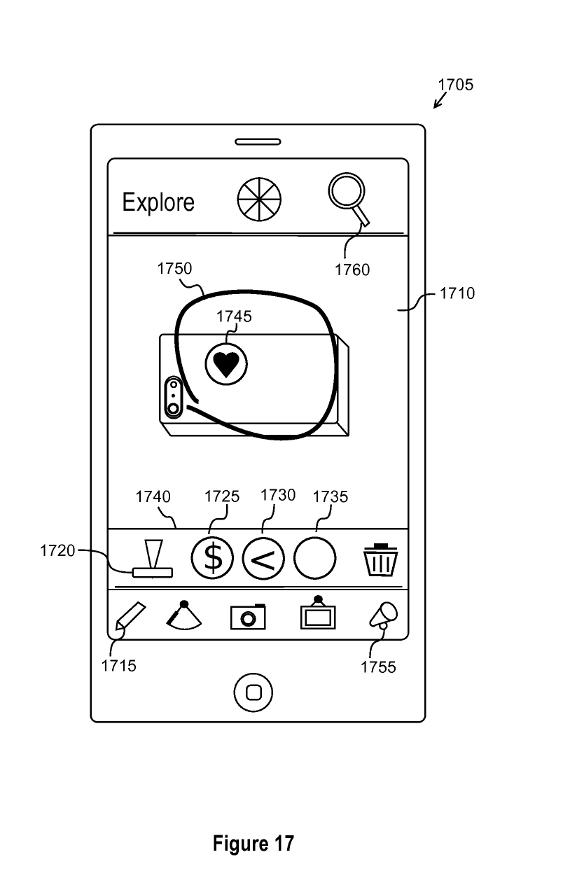

FIGS. 17-21 illustrates how units of conversation are categorized into the same or separate mini-conversation threads and a method of browsing them. In the example illustrated in FIGS. 17-21, four users send Private units of conversation to each other on an example client application using mobile devices.

FIG. 17 shows an example client application GUI 1705 on User 1's mobile device after User 1 has added inputs to the photograph in Image Editor 1710 using Action Button 1715 to draw a circle on the photograph, illustrated as Sketch 1750. User 1 also used Action Button 1720 to add Stamps 1725, 1730, 1735, and 1745. User 1 has dragged Stamp 1745 from the default position in Comment Editor 1740 to Image Editor 1710 and placed it on top of the phone case in the photograph. Stamp 1745 becomes part of the image created, along with the photograph and Sketch 1750.

Then User 1 can select Action Button 1755 to submit all the content in Image Editor 1710 and Comment Editor 1740 to the client application server for processing and delivery. Here, the photograph with stamp 1745 and Sketch 1750 is the Image and the stamp string with Stamps 1725, 1730 & 1735 is the associated Comment. Together, this comprises the Image and Comment comprises a unit of conversation that is sent to the client application server by selecting Action Button 1755. This unit of conversation does not have a parent so the parent ID is zero. This is also a top level unit of conversation, meaning it has its own original image, and is a Root seyZ.

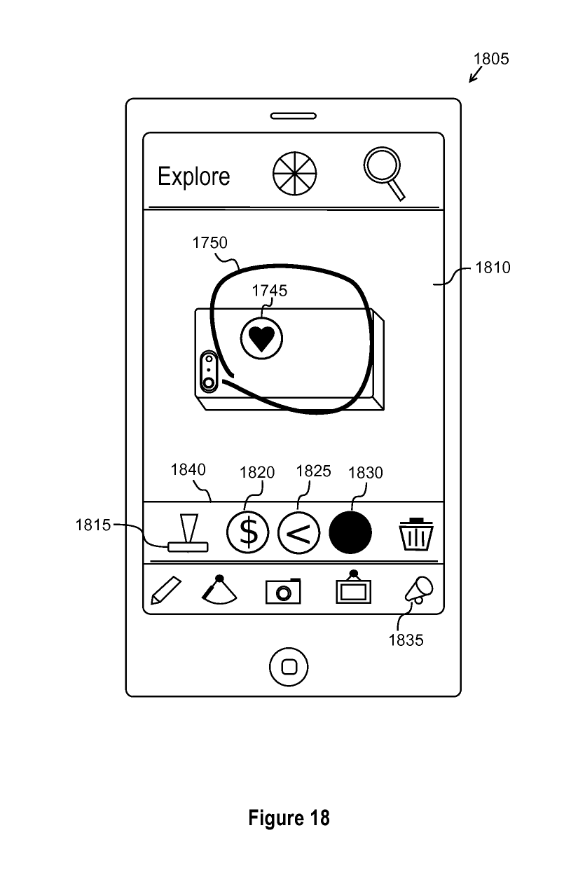

FIG. 18 shows an example client application GUI 1805 on User 2's mobile device after he receives the Private unit of conversation from User 1 and has added his own input to create a unit of conversation on his own mobile device. User 2 used Action Button 1815 to add Stamps 1820, 1825, and 1830 to Comment Editor 1840 to create a stamp string conveying a different sentiment about the Image. User 2 does not add any sketches or stamps to the image in Image Editor 1810 so it remains unaltered and is the same original Image, the photograph with Stamp 1745 and Sketch 1750, that User 1 created. User 2 then selects Action Button 1835 to send the contents of Image Editor 1810 and Comment Editor 1840 to the seyZme server for processing and delivery. In the present example of FIG. 18, the unit of conversation created by User 2 is called a reseyZ. It has a parent and the parent ID is User 1's ID. It is not a top level seyZ since it only has a Comment Type unit of conversation and doesn't have its own image, and is a Branch seyZ.

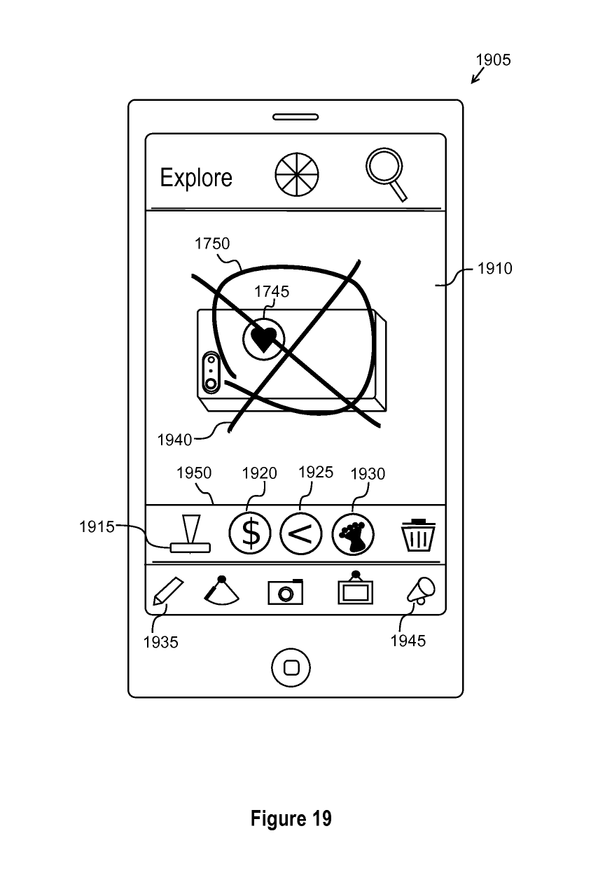

FIG. 19 shows an example client application GUI 1905 on User 3's mobile device after he receives the Private seyZ from User 1, created a unit of conversation response to User 1's unit of conversation, and is ready to send it out. User 3 used Action Button 1915 to add Stamps 1920, 1925, and 1930 to Comment Editor 1950 to convey his sentiments and has modified User 1's image by selecting Action Button 1935 and sketching an X, illustrated as Sketch 1940 onto the Image in Image Editor 1910. User 2 can then select Action Button 1945 to send the contents of Image Editor 1910 and Comment Editor 1950 to the client application server for processing and delivery. In some embodiments, the unit of conversation created by User 3 is called a reseyZ. It has a parent and the parent ID is User 1's ID. However it is a top level seyZ since it has its own original image, a modified version of User 1's original image, and is a Branch seyZ.

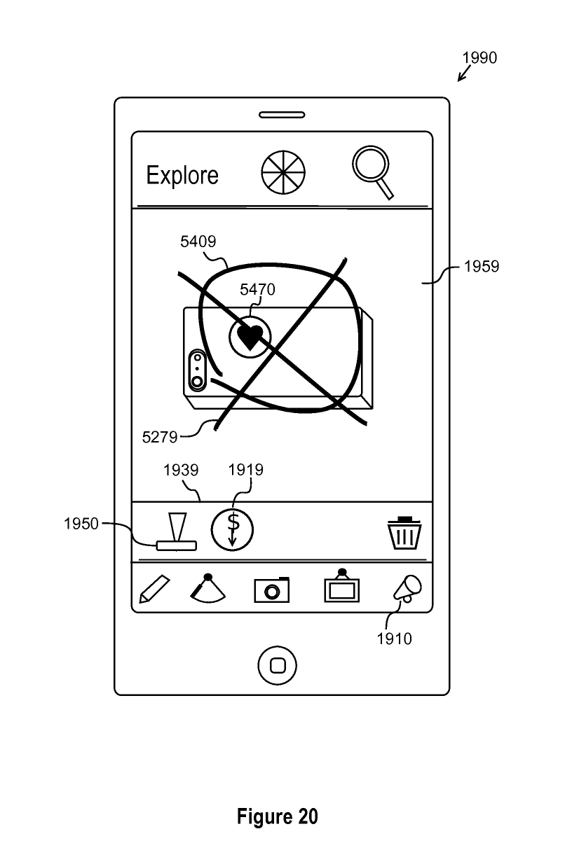

FIG. 20 shows an example client application GUI 2005 on User 4's mobile device after he receives the Private seyZ from User 3, created a unit of conversation response to User 3's unit of conversation, and is ready to send it out. User 4 used Action Button 2015 to add Stamp 2020 in Comment Editor 2030 to convey his sentiments. He has left User 3's image unaltered. User 4 then selects Action Button 2025 to send the contents of Image Editor 2010 and Comment Editor 2030 to the client application server for processing and delivery. In some embodiments, the unit of conversation created by User 4 is a reseyZ. It has a parent and the parent ID is User 3's ID. It is not a top level seyZ since it doesn't have its own image but uses the same original image as User 3. It is also a Branch seyZ.

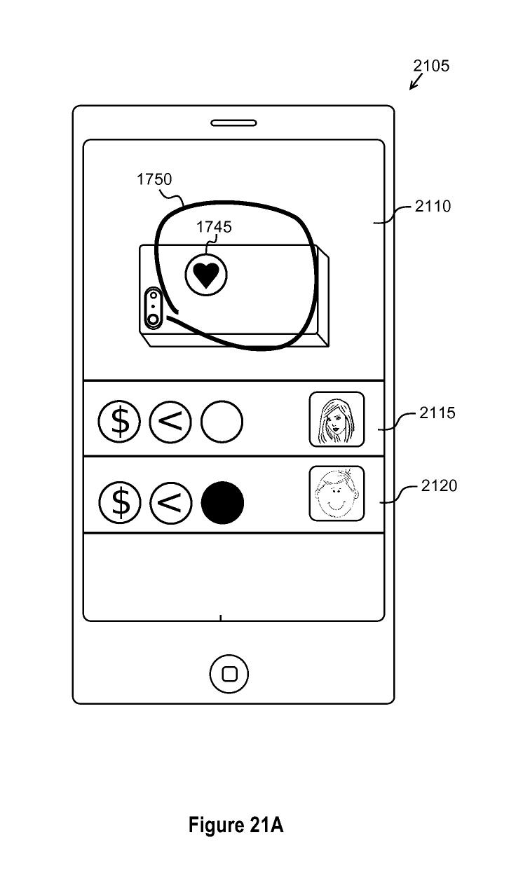

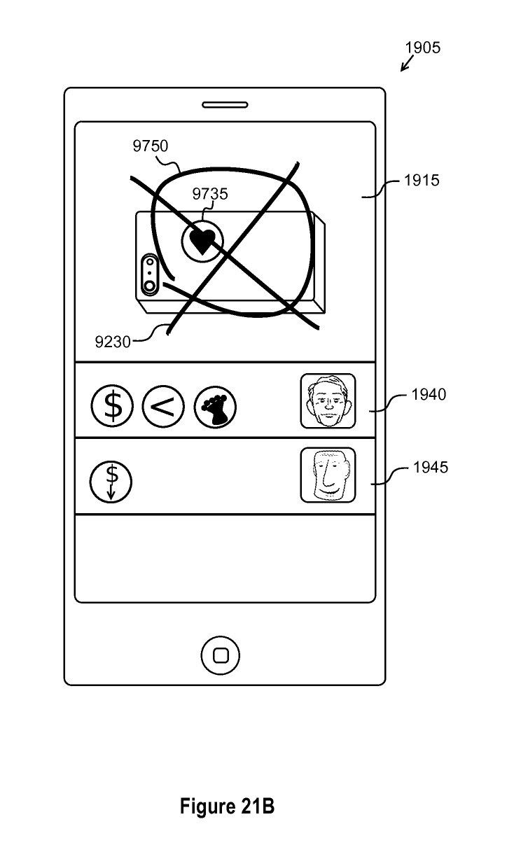

FIGS. 21A and 21B illustrate a method of browsing conversation threads on an example client mobile application. Returning to the example of FIG. 17, User 1 can browse all the conversations related to her original Root seyZ, including conversation threads based on the original image she submitted to the application server in the unit of conversation she created, as well as based on any modified images from her original image.

In the example of FIG. 21A, a Browse GUI 2105 is displayed on User 1's mobile device upon selecting Action Button 1760 in FIG. 17. Browse GUI 2105 shows the top level seyZ originated by User 1 in Image Display 2110. This is User 1's original image with the photograph, Stamp 1745, and Sketch 1750. Below it is displayed User 1's original Comment Type unit of conversation in Comment Display 2115 and User 2's reseyZ in Comment Display 2120.

FIG. 21B illustrates browsing for a second conversation thread that is separate but related to User 1's original unit of conversation, since it is based off a modified version of the Image submitted in User 1's original unit of conversation. In the example of FIG. 21B, Browse GUI 2005 displays the modified Image submitted in User 3's unit of conversation in Image Display 2125 where User 3 added Sketch 1940 to User 1's original image. Below it is displayed User 3's Comment Type reseyZ in Comment Display 2130 and User 4's Comment type reseyZ about User 3's submitted image in Comment 2135.

In some embodiments, a user may scroll up and down to see all the Comment Type units of conversation within a conversation thread that is associated with an image, and swipe right and left to move between different conversation threads (e.g., to get from the conversation thread in the example of FIG. 21A to the separate conversation thread in the example of FIG. 21B). But one skilled in the art will recognize that there are many different ways that comments within each conversation thread can be displayed, as well as each separate conversation thread (e.g., continuous up and down scrolling only, swiping left and right only, a randomly shuffled display, etc.).

G. Receiving Notification Queues

A user can browse conversation threads at any time in a client application. Returning to the example client mobile application GUI 405 illustrated in FIG. 4, the user can do this at any time by selecting Explorer Button 455 to display a Browsing GUI. In some embodiments, the client application server can send notifications to a user when different events occur that may prompt the user to browse a unit of conversation, communication or conversation thread. These events may include: when a Private communication is received from another user or group of users; when the client application server wants to send you a message; when a third party sponsor sends a communication or special offer; or when a public context specific unit of conversation that would be of interest to a user is detected.

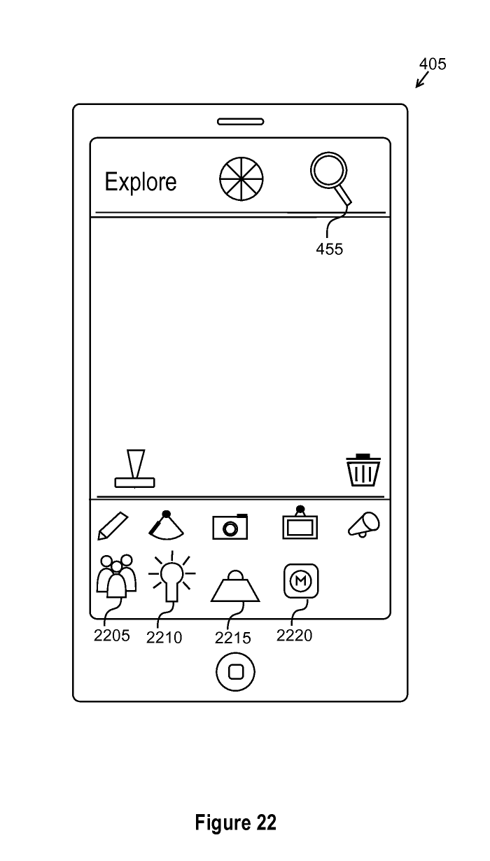

FIG. 22 illustrates one embodiment of an example GUI 405 when Client Application Server 300 in FIG. 3 sends a message to Mobile Application 400 in FIG. 2 to prompt Presentation Layer 402 to display one or more notification queues: User Queue 2205, System Queue 2210, Activity Based Queue 2215, and Sponsored Queue 2220.

User Queue 2205 is displayed in GUI 405 to notify a user that a Private unit of conversation has been received. In some embodiments, the user may select Explorer Button 455 to display the Browsing GUI or select User Queue 2205 to display the Browsing GUI and see the newly received unit of conversation.

System Queue 2210 is displayed in GUI 405 when Client Application Server 300 determines that something is important or would be of interest to a user. For example, if a user sends a unit of conversation complaining about the quality of a product, and the Client Application Server 300 received an enormous number of images with the same sentiments, it may prompt Mobile Application 400 to display System Queue 2210 and tell you how many other users complained of the same issue. This would be something that one user may never have known if the system didn't recognize it and affirmatively notify him or her.

Activity Based Queue 2215 is displayed when something that pertains to a context a user has indicated interest in (e.g., selected categories) or that the system recognizes may be of interest to you (e.g., special offers based on the shopping context units of conversation that a user sends). For example, when there are sales or coupons for a shopping store that you frequently send units of conversations about, a shopping specific Activity Based Queue 2215 will be displayed in GUI 405.

Sponsored Queue 2220 is displayed when sponsors want to send targeted users special offers or coupons based on their indicated interest (e.g., selected categories) or types of units of conversations a user sends. Different entities (e.g., people, companies, organizations) can use these special queues for different purposes such as to advertise products or services, to perform market research, etc. Entities pay a fee to send these special queues.

What is claimed is:

1. A method for defining a user interface (UI) for creating and specifying stamps for a piece of content, the method comprising:
defining a first set of UI items for selecting a first stamp;
defining a second set of UI items for selecting a second stamp;
defining a third set of UI items for selecting a relationship operator stamp that identifies a relationship between the first stamp and the second stamp;
defining a fourth set of UI items for adding user input; and
defining a fifth set of UI items for receiving user input.

2. The method of claim 1, wherein the first set of UI items comprises a list of stamps that are displayed in all contexts at all times.

3. The method of claim 1, wherein the second set of UI items comprises a list of context-specific stamps defined by determining the user's geo-location.

4. The method of claim 1 wherein at least one of the first, second, and third stamps is a sponsored stamp.

5. The method of claim 1, wherein the fourth set of UI items comprises a sketch tool to allow the user to create sketches and designs.

6. The method of claim 1, wherein the fifth set of UI items allows a user to propose new stamps.

7. A non-transitory computer readable medium storing a computer program for execution by at least one processor, the computer program comprising sets of instructions for:
receiving identification of a first stamp;
receiving identification of a second stamp;
receiving identification of a relationship operator stamp;
defining a link of a stamp chain by creating a relationship between the first stamp and the second stamp using the relationship operator stamp to describe the relationship between the first stamp and the second stamp; and
receiving identification of user input.

8. The non-transitory computer readable medium of claim 7, wherein user input is the sketch of a new proposed stamp.
